(19) United States
(12) Patent Application Publication
(10) Pub. No.: US 2018/0320434 A1
(43) Pub. Date: Nov. 8, 2018

(54) MULTI-GLAZED WINDOW INCORPORATING A NOISE REDUCTION DEVICE

(71) Applicants: Christian CARME, Marseille (FR); TECHNOFIRST, Aubagne (FR)

(72) Inventor: Christian CARME, Marseille (FR)

(21) Appl. No.: 15/772,894

(22) PCT Filed: Nov. 2, 2016
(86) PCT No.: PCT/FR2016/052839

§ 371 Date: May 2, 2018

(30) Foreign Application Priority Data
Nov. 2, 2015 (FR) 1560491

(51) Int. Cl. E06B 3/67; E06B 5/20; G10K 11/178; H04R 7/04; H04R 7/18

(52) U.S. Cl. CPC E06B 3/67; E06B 5/20; G10K 11/178; G10K 2210/3219; H04R 7/18; G10K 2210/129; H04R 7/04

(57) ABSTRACT

A multi-glazed window incorporating an active or passive noise reduction device, with at least one vibrating membrane disposed between two adjacent glass panes in such a way as to vibrate in the air layer separating the two glass panes. The device includes a hollow body with two longitudinal side walls and one face of which is constituted at least partially by the membrane suspended at the side walls, on either side of same. The membrane has two distal edges at each of which is arranged an attachment member, which attachment member engages with a complementary attachment member arranged on a respective side wall of the body.

### TECHNICAL FIELD OF THE INVENTION

The invention has for object a multi-glazed window incorporating a noise reduction device.

It relates to the technical field of devices that make it possible to improve the sound insulation of a window.

### PRIOR ART

Document U.S. Pat. No. 6,285,773 (Carme) discloses an active noise rejection system, comprising one or several linear loudspeakers arranged at the edge of a double glazing, in the air layer between the two glass panes and/or inside a framing profile of this double glazing. In this noise rejection system, the loudspeaker makes it possible to realize an electro-acoustic system that is practically invisible, and which is not detrimental to visual comfort or to the light transmission of the glazing, with the proposed system making it possible to improve the sound insulation of a double glazing in particular in the low frequencies.

The loudspeaker described in the Carme patent, comprises a vibrating membrane disposed between two adjacent glass panes in such a way as to vibrate in the air layer separating said two glass panes. It also comprises a hollow body one face of which is constituted at least partially by a membrane suspended on side walls of said body which are adjacent to said membrane.

The Carme patent proposes various solutions in order to provide the junction between the membrane and the side walls of the body of the loudspeaker.

In a preferred embodiment, the two longitudinal edges overhanging from this membrane are folded back against the longitudinal side walls of the body, and are fixed exteriorly on these walls, or under the bottom, by a gluing.

In an alternative embodiment, an elastic seal in the shape of a sausage, for example made of rubber, is glued on the one hand under the edges of the membrane, and on the other hand on the upper edges of the side walls of the body. The seal is alternatively compressed and stretched (in its section) during the vibrating movement of the membrane.

The junction can also be provided by an elastic seal in the shape of a bellows, i.e. having a zig-zag section, which is also glued on the one hand under the edges of the membrane, and on the other hand on the upper edges of the side walls of the body.

This junction can finally be provided by an elastic seal in the shape of a sausage, glued on the one hand against the edges of the membrane, and on the other hand against the inside of the side walls of the body, practically on the upper edges of these side walls.

The technical solutions proposed in the Carme patent make it possible to suspend the membrane in such a way that it is constantly tight and in a “balanced” manner, i.e. by generating the same elastic return force for a displacement in one direction or in the other of said membrane, in such a way that the latter has, during its vibratory movement, a symmetrical deformation on either side of its rest position.

In practice, the gluing creates irregularities at the junction between the membrane and the side walls of the body of the loudspeaker, in such a way that the tension in said membrane is not homogeneous. The applicant was able to observe that this defect, if it were not controlled, could result in a dissymmetric deformation of the membrane, and therefore a decrease in the output of the transducer and incidentally of the sound insulation. Furthermore, the quality of this connection by gluing can be degraded over time, in particular due to the UVs and the thermal variations to which the window is subjected.

The invention aims to overcome this situation. In particular, an objective of the invention is to provide a junction between the membrane and the side walls of the body which guarantees a homogenous tension, or practically homogeneous, of said membrane.

Another objective of the invention is to provide a junction between the membrane and the side walls of the body of which the quality is constant over time.

An additional objective of the invention is to propose a multi-glazed window of which the sound insulation is improved in relation to that obtained by the implementation of the Carme patent.

Yet another objective of the invention is to propose a noise reduction device that is of simple design and easy to install.

### DISCLOSURE OF THE INVENTION

The solution proposed by the invention is a multi-glazed window incorporating an active or passive noise reduction device, said device comprises at least one vibrating membrane disposed between two adjacent glass panes in such a way as to vibrate in the air layer separating said two glass panes, which device comprises a hollow body comprising two longitudinal side walls and one face of which is constituted at least partially by the membrane suspended at said side walls, on either side of said longitudinal side walls.

This window is remarkable in that:
the membrane has two distal edges at each of which is arranged an attachment member, which attachment member engages with a complementary attachment member arranged on a respective side wall of the body,

The junction between the membrane and the side walls of the body is therefore now provides very simply and very rapidly by a mechanical connection that provides a homogeneous tension, or practically homogeneous, of said membrane. Furthermore, this mechanical connection does not suffer from any degradation over time, in particular due to the UVs and the thermal variations to which the window is subjected.

Other advantageous characteristics of the invention are listed hereinbelow. Each one of these characteristics can be considered alone or in combination with the remarkable characteristics defined hereinabove, and be the object, where applicable, of one or several divisional patent applications:
An attachment rib can be arranged at each distal edge of the membrane, which rib is housed in a complementary attachment groove arranged on the respective side wall of the body.
In an alternative embodiment, an attachment groove is arranged at each distal edge of the membrane, which groove is housed in a complementary attachment rib arranged on the respective side wall of the body.
Each attachment member arranged on the respective side wall of the body is advantageously associated with an adjusting device suitable for modifying the position of the complementary attachment member of the membrane, with this modification in position generating a variation in the tension of said membrane.
The window is preferably comprised of a frame formed of profiles surrounding the two adjacent glass panes, the hollow body forming one of said profiles.
The membrane can be attached to a movable rigid piston.
The membrane preferably has two proximal edges at each of which is arranged an attachment member, which attachment member engages with a complementary attachment member arranged on the piston.
An attachment rib can be arranged at each proximal edge of the membrane, which rib is housed in a complementary attachment groove arranged on the piston.
In an alternative embodiment, an attachment groove is arranged at each proximal edge of the membrane, which groove is housed in a complementary attachment rib arranged on the piston.
The piston is advantageously integral with a rigid wing which extends towards the bottom of the hollow body in the longitudinal median plane of said body, which wing carries an electromagnetic coil connected to an electrical power supply, which coil is arranged between two fixed magnets placed in the hollow body, said coil and said magnets cooperating in such a way as to induce a vibratory movement of said piston when said coil is electrically powered.
The rigid wing is preferably suspended from fixed portions of the body by elastomer elements arranged symmetrically with respect to the longitudinal median plane of said body, which elastomer elements each have: —a distal edge at which is arranged an attachment member that engages with a complementary attachment member arranged on a fixed portion of the body; —and a proximal edge at which is arranged an attachment member that engages with a complementary attachment member arranged on the rigid wing.

### DESCRIPTION OF THE FIGURES

Other advantages and characteristics of the invention shall appear when reading the following description of a preferred embodiment, in reference to the annexed drawings, realized by way of indicative and non-limiting examples and wherein:

FIG. 1 is a cross-section view of a noise reduction device in accordance with the invention, according to a first embodiment,

FIG. 2 is a cross-section view of a noise reduction device in accordance with the invention, according to a second embodiment,

FIG. 3 is a cross-section view of a noise reduction device in accordance with the invention, according to a third embodiment,

FIG. 4 is a cross-section view of a noise reduction device in accordance with the invention, according to a fourth embodiment,

FIG. 5 shows in detail an adjusting element suitable for modifying the position of the attachment member of the membrane.

### PREFERRED EMBODIMENTS OF THE INVENTION

This invention relates to a multi-glazed window, which is characterized by a particular design of the noise reduction device that it integrates.

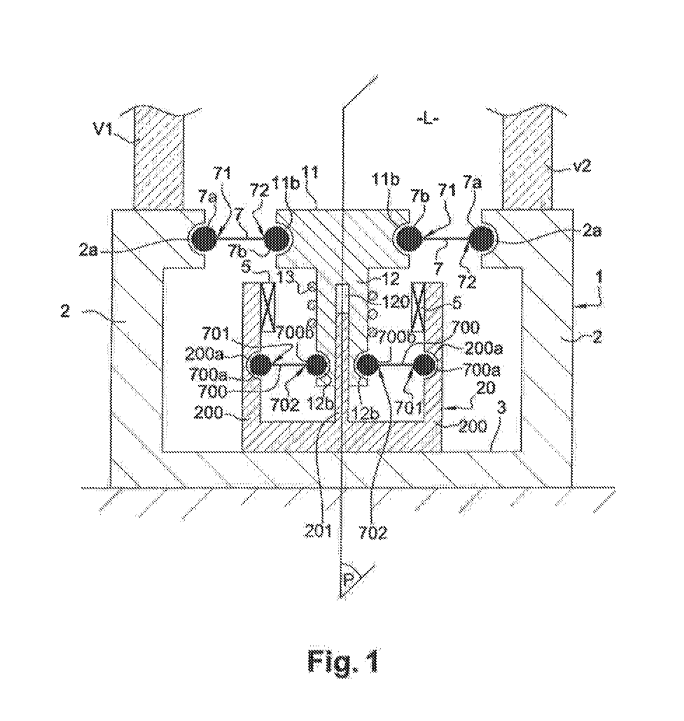

The window itself is of a known type. It is comprised of a frame, formed of profiles surrounding a glass panel. In FIG. 1, the latter is formed by two adjacent glass panes V1 and V2 separated by an air layer L. The frame is preferably of rectangular or square shape, but can be polygonal, have one or several curved edges, etc.

The noise reduction device is used for an active or passive control of the noise. In active mode, it generates in the air layer a sound level equivalent to the ambient sound level to be controlled (in particular for noisy environments). In the passive mode, it absorbs all or a portion of the sound waves propagating in the air layer L.

An active noise reduction device can have the form of a piezoelectric actuator or a loudspeaker. Preferably use is made of a linear loudspeaker of the type described in U.S. Pat. No. 6,285,773 (Carme) mentioned hereinabove, and to which those skilled in the art can refer where applicable. This type of linear loudspeaker can indeed be housed easily in a reduced volume and in particular in a narrow space, while still having an output comparable to that of a conventional loudspeaker with conical membranes. The geometrical shape and the particular arrangement of the elements that comprise the linear loudspeaker offer a very satisfactory output. In particular, in light of the substantial length of the membrane, the latter displaces a large mass of air during its vibration, which allows for good output in the low frequencies.

Use will be made in the rest of the description of the generic term loudspeaker, whether the latter is active or passive.

In accordance with the invention, the noise reduction device can include a single linear loudspeaker arranged on a single of the sides of the frame of the window, or several linear loudspeakers arranged respectively on the various sides of said frame. The choice of the number of loudspeakers and of their arrangement in the frame of the window depends on the sound field to be attenuated, by superposition (active reduction of the noise) or absorption (passive reduction of the noise), with noises propagating in the air layer L, in order to increase the sound insulation of the double glazing.

The FIG. 1 diagrammatically shows a linear loudspeaker, which exteriorly has the form of a hollow body 1 in the form of an elongated rectangle parallelepiped, having for example a length from 50 cm to 2 m, a width from 2 cm to 4 cm and a depth from 2 cm to 4 cm. The body 1 can be made from aluminum, steel, plastic, or of any other material that suits those skilled in the art and advantageously forms one of the profiles of the frame of the window. In the cross-section of FIG. 1, the hollow body 1 is delimited by two longitudinal side walls 2 and a bottom 3.

At least one face of the body 1 is constituted at least partially by a vibrating membrane 7 which is suspended on side walls 2 and extends on either side of same. In the annexed figures, the membrane 7 is installed on the upper face of the body 1, opposite the bottom 3. In this configuration, the membrane 7 is arranged between the two adjacent glass panes V1, V2 in such a way as to vibrate in the air layer L. This membrane 7 is flat and for the case of a linear loudspeaker, it is extended. It preferably extends over the entire length of the body 1.

The membrane 7 is formed by a film with elastic properties, such as an elastomer having an elastic power or a polyethylene film.

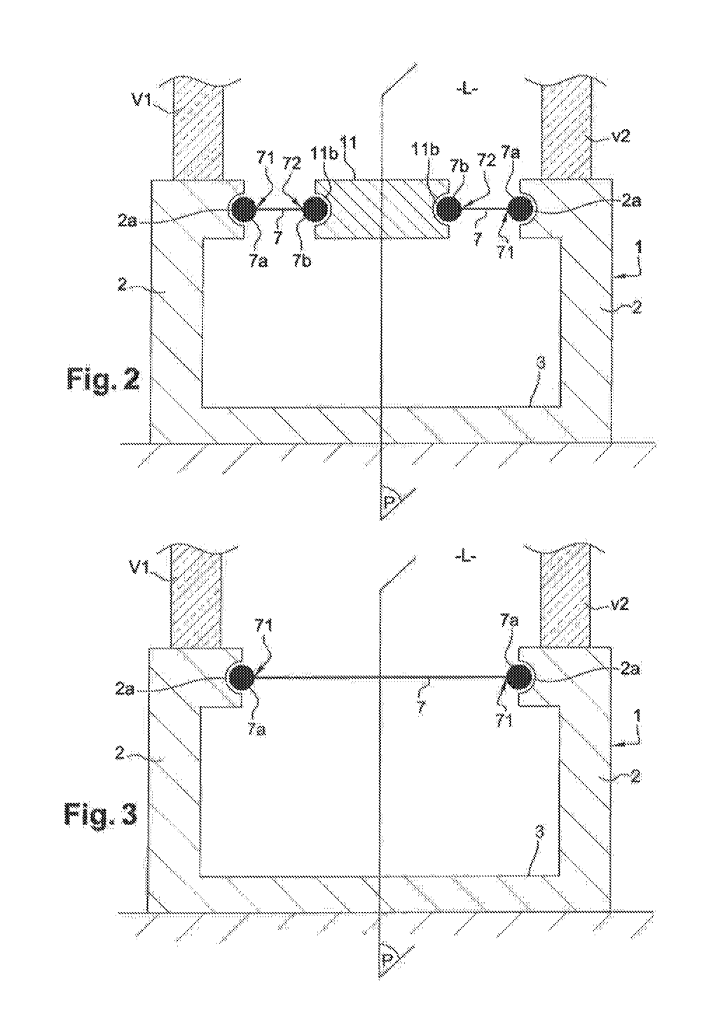

In the embodiments of FIGS. 1 and 2, the membrane 7 is integral with a movable rigid piston 11. The latter is made from a light material such as aluminum, a plastic, a composite material (for example: carbon fiber), with possibly a honeycomb structure in order to further lighten the part. It has a complementary shape of the membrane 7, and in the case of a linear loudspeaker has the shape of an extended rectangular plate.

In FIG. 1, the piston 11 is integral with a rigid wing 12 which extends towards the bottom 3 of the body 1, in the longitudinal median plane P of said body. The assembly has a cross-section in the general shape of a “T”. In the case of a linear loudspeaker, the wing 12 extends longitudinally in the body 1, in the same way as the membrane 7 and the piston 11. The wing 12 can be added onto the lower face of the piston 11, or be an integral part of the latter, in which case the piston 11 and the wing 12 form a one-piece part.

The wing 12 carries an electromagnetic coil 13 connected to an electrical power supply. This coil 13 is wound around the outer lateral faces of the wing 12, in the length of the latter, parallel to the plane of the membrane 7. Thanks to this extended coil 13 extending below the membrane 7, the forces are evenly distributed over the length of said membrane, limiting as such the distortions. Furthermore, this configuration makes it possible to obtain a practically pure resistive behavior of the coil 13. Regardless of the acoustic frequencies to be treated, there is no weighting according to the impedance of the loudspeaker, which translates into an absence of unpredictable behavior. The coil 13 is preferably comprised of a copper wire 0.2 mm in diameter forming about ten turns around the wing 12.

The coil 13 is arranged between two fixed magnets 5 placed in the body 1. In FIG. 1, the magnets 5 are installed on fixed polar portions 200, arranged in the body 1, symmetrically on either side of the longitudinal median plane P, parallel to the wing 12. The fixed magnets 5 are as such placed outside of the movable coil 13 on either side of the two large sides of this coil 13.

The polar portions 200 are completed with a central fixed polar portion 201 located in the longitudinal median plane P. The wing 12 has a recess 120, open towards the bottom 3, wherein is engaged in a sliding manner the central fixed polar portion 201. The latter extending practically over the entire length of the membrane 7, provides a good guiding of the movement of the latter, over its entire length.

All of these polar portions 200, 201 are advantageously brought together in the form of a profile 20 with a “ [symbol] ” shape. The latter can be obtained by molding or extrusion and be added in the body 1 and fixed onto the bottom 3 by any suitable means of fastening. The profile 20 has the same length or substantially the same length as the wing 12 and/or of the coil 13. Contrary to the solution disclosed in U.S. Patent document 6.285.773 (Carme) mentioned hereinabove, it is no longer the side walls 2 of the body 1 that form the polar portions, but the side walls 200 and the central wall 201 of the profile 20. This is particularly advantageous in that the body 1 and the profile 20 are two separate parts that can each be made from a different material: the body 1 from a non-metal material (for example a plastic) and the profile 1 from a metal material (for example a steel).

The magnets 5 can have a length equivalent to that of the coil 13. With a concern for costs, it is advantageous to provide several magnets 5 placed end-to-end in the lengthwise direction of the polar portions 200, above the bottom 3 and below the membrane 7. The magnets 5 are arranged on the polar portions 200 in such a way that their facing face has the same polarity (enantiomeric arrangement).

The coil 13 and the magnets 5 cooperate in such a way as to induce a vibratory movement in the piston 11, and therefore in the membrane 7, when said coil is electrically powered.

In a known manner, the management of the electrical power supply of the coil 13 is provided by a control electronics (not shown) connected to one or several acoustic microphones (not shown) such as shown in FIG. 8 of U.S. Patent document 6.285.773 (Carme) mentioned hereinabove. The passage in the coil 13 of an electric signal representative of the counter-noise generates an electromagnetic force in the wing 12. Due to the symmetry of the poles of the magnets 5, the flows induced are in the same direction, which generates the displacement of the wing 12 and of the piston 11 in the same direction according to the vertical direction of FIG. 1, and causes the vibration of the membrane 7 which generates the counter-noise.

The acoustic microphone or microphones sent a signal that represents the noise in the air layer L to the control electronics. The algorithms used to generate the counter-noise can be of the feedback type and/or feedforward type. Then, the control electronics emit an electric control signal to the coil 13 according to the noise signal to be treated. This active noise reduction device makes it possible to increase the sound insulation of the double glazing.

In FIG. 1, the membrane 7 has two distal edges 71 (located respectively at the right outer end and at the left outer end of the membrane 7 in FIG. 1) and two proximal edges 72 (located respectively at the right inner end and at the left inner end of the membrane 7 in FIG. 1). An attachment member 7a is arranged at each one of the distal edges 71. This attachment member 7a engages with a complementary attachment member 2a arranged on a respective side wall 2 of the body 1. This mechanical connection between the membrane 7 and the body 1 provides an external or peripheral suspension of said membrane and guarantees a homogeneous tension, or practically homogeneous, of said membrane. Contrary to the solution by gluing recommended in U.S. Patent document 6.285.773 (Carme) mentioned hereinabove, a mechanical fastening of the membrane 7 onto the side walls 2 of the body 1 is simple, fast, reliable and sustainable over time. Also, the deformation of the membrane 7 during vibration, which is elastically suspended at the walls 2 by this mechanical connection, remains symmetrical on either side of its mean rest position shown in FIG. 1. Furthermore, the membrane 7 is maintained linked to the body 1 and not to the polar portions 200, 201, which makes it possible to optimize the design of the profile 20, in particular in terms of thickness and compactness.

In order to simplify the design and the setting in place of the membrane 7, the attachment members each have the form of an attachment rib 7a which is arranged at each distal edge 71 of said membrane. When the membrane 7 is rectangular, this annular rib 7a extends over the entire length of said membrane and possibly over the small sides of said membrane, at each end. Each rib 7a is preferably made from the same material as the membrane 7 and obtained during the molding of the latter. It is preferably annular, of circular section and of which the diameter is between 2 mm and 5 mm.

Each rib 7a is housed in a complementary attachment groove 2a arranged on the respective side wall 2 of the body 1. The groove 2a is for example obtained by machining or during the molding of the body 1. The setting up of the membrane 7 is as such carried out very simply by inserting the ribs 7a into the grooves 2a.

Preferably, each rib 7a is tightly fitted into the complementary groove 2a in such a way that said rib does not pivot in said groove when the membrane vibrates. This characteristic also makes it possible to prevent any risk of untimely detaching of the membrane 7. Furthermore, a hermetic junction is provided between the membrane 7 and the body 1 i.e. the air cannot pass at this junction. For this, the groove 2a can have dimensions, in particular a diameter, less than that of the rib 7a. In the case where the latter is flexible, the insertion thereof into the groove 2a is made possible by deformation.

In FIG. 1, the proximal edges 72 are adjacent to the longitudinal lateral edges of the piston 11. In order to ensure the junction between the membrane 7 and the piston 11, it is also provided to arrange an attachment member 7b at each proximal edge 72. Said member 7b engages with a complementary attachment member 11b arranged on the piston 11. This is therefore the same type of mechanical connection that is simple, fast, reliable and sustainable over time qui that provides an internal suspension of the membrane 7 on the piston 11 and guarantees a homogeneous tension, or practically homogeneous, of said membrane. The symmetry of the mechanical connections at on the one hand the distal edges 71 and on the other hand the proximal edges 72, contributes to optimizing the symmetrical deformation of the membrane 7 on either side of its mean rest position shown in FIG. 1.

In order to simplify the design and the setting in place of the membrane 7, each attachment member has the form of an attachment rib 7b which is arranged at the corresponding proximal edge 72. This rib 7b preferably follows the contour of the piston 11. The rib 7b is preferably made from the same material as the membrane 7 and obtained during the molding of the latter. It is preferably annular, of circular section and of which the diameter is between 2 mm and 5 mm.

Each rib 7b is housed in a complementary attachment groove 11b arranged on the piston 11, and more particularly on a corresponding longitudinal lateral edge of the latter. In FIG. 1, when the membrane 7 is in the rest position, the grooves 7a and 11b are aligned in the same horizontal plane in such a way that said membrane is perfectly flat. The groove 11b is for example obtained by machining or during the molding of the piston 11. The setting up of the membrane 7 is as such carried out very simply by inserting each rib 7b into the complementary groove 11b. For the same reasons as mentioned hereinabove, each rib 7b is preferably tightly fitted into the complementary groove 11b, providing a hermetic junction between the membrane 7 and the piston 11.

At rest (FIG. 1), the membrane 7 is not stretched, i.e. it is not subjected to any tension force, or the force is negligible. When the coil 13 is electrically excited and the piston 11 rises or descends, the membrane 7 is tensioned due to the fact that the assembly 70-2a is fixed while the assembly 7b-11b is movable. The membrane 7 therefore always works in tension, offering further linearity in the displacement thereof.

In the configuration of FIG. 1, as in that shown in U.S. Patent document 6.285.773 (Carme) mentioned hereinabove, it is possible to observe a rolling phenomenon of the piston 11 when the latter vibrates. Indeed, the piston 11 can have a small rotation about the longitudinal axis thereof due to the play that exists between the recess 120 and the central polar portion 201. This rolling effect affects the behavior of the membrane 7 and can degrade the attenuation of the noise.

Without rolling, the piston 11 has a mono-polar behavior. The vibration of the piston 11 is homogeneous over its entire surface: at a given instant, it “pushes” and “pulls” the air homogeneously (mono-polar behavior of the piston).

With rolling, the piston 11 has a dipolar behavior. The vibration of the piston 11 is not homogeneous over its entire surface: at a given instant, the air is “pushed” over a portion of the surface of the piston 11, and “pulled” in an equal proportion over the remaining portion of the surface of said piston. The two effects tend to cancel each other out, potentially reducing the capacity of the piston 11 to attenuate the noise.

In order to overcome this, the rigid wing 12 is preferably suspended at fixed portions of the body 1 by elastomer elements 700 arranged symmetrically with respect to the longitudinal median plane P of said body 1. In the example of FIG. 1, the rigid wing 12 is suspended at the polar portions 200. The piston 11 is then suspended in its upper portion by the membrane 7, and in its lower portion by the elements 700. This double suspension tends to limit, and even cancel, the rolling effect mentioned hereinabove. The elements 700 are similar to the membrane 7 and made from the same material. They are flat, and for the case of a linear loudspeaker, they are extended. They preferably extend over the entire length of the body 1.

The elements 700 each have a distal edge 701 and a proximal edge 702. An attachment member 700a is arranged at each distal edge 701, which member engages with a complementary attachment member 200a arranged on a fixed portion 200 of the body 1. An attachment member 700b is also arranged at each proximal edge 702, which member engages with a complementary attachment member 12b arranged on the wing 12. The attachment members 700a-200a and 700b-12b are identical to those described hereinabove.

FIGS. 2, 3 and 4 show alternative embodiments. In FIG. 2, the noise reduction device is a passive device, without any magnetic component integrated into the body 1. The piston 11 is also devoid of a wing. The fastening of the membrane 7 on the one hand onto the side walls 2 and on the other hand onto the piston 11, is carried out by the intermediary of attachment members 7a-2a and 7b-11b identical to those described hereinabove in reference to FIG. 1. In this configuration, the membrane 7 absorbs all or a portion of the sound vibrations propagating in the air layer L, making it possible to increase the sound insulation of the double glazing.

In FIG. 3, the noise reduction device is also a passive device similar to that of FIG. 2, without any magnetic component integrated into the body 1, or piston 11. The membrane 7 is simply suspended at the side walls 2 of the body 1 and extends on either side of said walls. Only the attachment member 7a arranged on each distal edge 71 is attached to the complementary attachment member 2a arranged on the respective side wall 2 of the body 1. The attachment members 7a and 2a are identical to those described hereinabove in reference to FIG. 1.

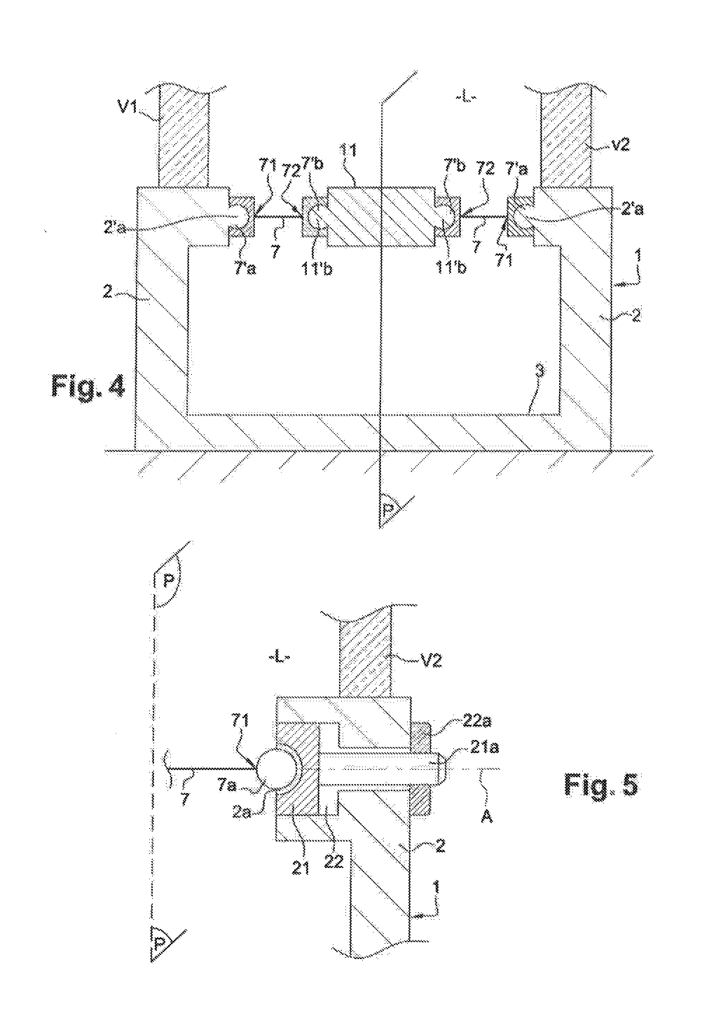

The embodiment of FIG. 4 is similar to that of FIG. 2, except in the design of the attachment members. An attachment groove 7′a is here arranged at each distal edge 71 of the membrane 7, which groove is housed in a complementary attachment rib 2′a arranged on the respective side wall 2 of the body 1. And an attachment groove 7′b is arranged at each proximal edge 72 of the membrane 7, which groove 7′b is housed in a complementary attachment rib 11′b arranged on the piston 11.

In the embodiments of FIGS. 2, 3 and 4, when the noise reduction device is passive, it can be advantageous to adjust the tension of the membrane 7 in such a way as to adjust its resonance frequency according to the volume of the air layer L and/or according to the sound frequency band to be reduced. Indeed, the double glazing acts as an acoustic system of the Mass/Spring/Mass type. The air layer L playing the role of a spring and the glass panes V1, V2 playing the role of mass. This system has a resonance frequency at which it is possible to absorber energy. By adjusting the tension of the membrane 7, it is possible to “tune” the resonance frequency so that the latter is, for example, equivalent to the first acoustic resonance mode of the air layer L. The noise reduction device therefore has the capacity to absorb a portion of the acoustic field of the air layer L. This absorption is done through the dissipation of energy (heat) into the membrane 7.

In order to adjust the tension of the membrane 7, and in reference to FIG. 5, each attachment member 2a arranged on the respective side wall 2 of the body 1 is advantageously associated with an adjusting device 21a, 22a suitable for modifying the position of the complementary attachment member 7a of the membrane 7, with this modification in position generating a variation in the tension of said membrane.

In FIG. 5, the groove 2a is carried out in a knob 21 mounted mobile in translation in a housing 22 arranged in the corresponding side wall 2. In order to prevent the knob 21 from pivoting in the housing 22, these elements preferably have a square or rectangular cross-section. This knob 21 is displaced in the plane containing the membrane 7, according to a horizontal direction A which is perpendicular to the median plane P. The knob 21 is integral with a threaded rod 21a that passes through the housing 22 and opens onto the outer lateral face of the wall 2, outside the body 1. An adjusting nut 22a is screwed onto the distal end of the threaded rod 21a. By screwing the nut 22a, the knob 21 is displaced towards the bottom of the housing 22, resulting in a tensioning of the membrane 7. By unscrewing the nut 22a, the knob 21 is displaced in the opposite direction, the membrane 7 relaxing. The nut 22a being outside the body 1, an operator can easily adjust the tension of the membrane 7 and therefore its resonance frequency.

The arrangement of the various elements and/or means of the invention, in the embodiments described hereinabove, must not be understood as requiring such an arrangement in all of the implementations. In any case, it is understood that diverse modifications can be made to these elements and/or means, without leaving the spirit and the scope of the invention. In particular:
The window can comprise more than two glass panes, in particular three glass panes.
The noise reduction device can have the form of a loudspeaker having a square or circular membrane (for example an ASCA loudspeaker marketed by the applicant); in this case, it is advantageous to install several of these circular loudspeakers, in alignment, in the same side of the frame of the window.
In the case where the form of the loudspeaker comprises a square or circular membrane, the hollow body 1 has a complementary shape which is delimited by side walls and a bottom.
The profile 20 can be directly integrated into the body 1 and formed with the latter a one-piece part obtained for example by molding or extrusion.
The membrane 7 can extend over only a portion of the total length of the body 1 and more particularly in only the median region of this body; with the latter delimiting as such towards its ends, on either side of said membrane, two empty internal spaces forming a tuning volume; the magnetic components 5, 13, 200, 201 can then also be limited, in their length, to this median region.
When the membrane 7 is square or circular, the rib 7a extends over the entire periphery of said membrane.
The ribs 7a and/or 7b and/or 2′a and/or 11′b can have a square, rectangular, oval or other section; the grooves 2a and/or 11b and/or 7′a and/or 7′b then having a complementary section.
The ribs 7a and/or 7b and/or 2′a and/or 11′b can be added onto the distal edge 71 and/or onto the proximal edge 72, for example by welding or pinching, and be made from a material that is different from that of the membrane 7, for example from a rigid material.
The adjusting device 21a, 22a can have any other form that suits those skilled in the art.
The loudspeaker can be used in any type of double wall for the sound system of a room (with the vibrating membrane 7 being arranged between two adjacent walls in such a way as to vibrate in the air layer separating the two said walls), or the mounting in or on exhaust or ventilation ducts, for the active treatment of the noise in these ducts.

1-11. (canceled)

12. A multi-glazed window incorporating an active or passive noise reduction device, comprising:
at least one vibrating membrane disposed between two adjacent glass panes in such a way as to vibrate in the air layer separating said two glass panes, which device comprises a hollow body comprising two longitudinal side walls and one face of which is constituted at least partially by the membrane suspended at said side walls, on either side of same, wherein the membrane has two distal edges at each of which is arranged an attachment member, which attachment member engages with a complementary attachment member arranged on a respective side wall of the body.

13. The window according to claim 12, wherein an attachment rib is arranged at each distal edge of the membrane, which rib is housed in a complementary attachment groove arranged on the respective side wall of the body.

14. The window according to claim 12, wherein an attachment groove is arranged at each distal edge of the membrane, which groove is housed in a complementary attachment rib arranged on the respective side wall of the body.

15. The window according to claim 14, wherein each attachment member arranged on the respective side wall of the body is associated with an adjusting device suitable for modifying the position of the complementary attachment member of the membrane, with this modification in position generating a variation in the tension of said membrane.

16. The window according to claim 12, wherein said window is comprised of a frame formed of profiles surrounding the two adjacent glass panes, the hollow body forming one of said profiles.

17. The window according to claim 12, wherein the membrane is integral with a movable rigid piston.

18. The window according to claim 17, wherein the membrane has two proximal edges at each of which is arranged an attachment member, which attachment member engages with a complementary attachment member arranged on the piston.

19. The window according to claim 18, wherein an attachment rib is arranged at each proximal edge of the membrane, which rib is housed in a complementary attachment groove arranged on the piston.

20. The window according to claim 18, wherein an attachment groove is arranged at the proximal edge of the membrane, which groove is housed in a complementary attachment rib arranged on the piston.

21. The window according to claim 17, wherein the piston is integral with a rigid wing which extends towards the bottom of the hollow body in the longitudinal median plane of said body, which wing carries an electromagnetic coil connected to an electrical power supply, which coil is arranged between two fixed magnets placed in the hollow body, said coil and said magnets cooperating in such a way as to induce a vibratory movement of said piston when said coil is electrically powered.

22. The window according to claim 21, wherein the rigid wing is suspended at fixed portions of the body by elastomer elements arranged symmetrically with respect to the longitudinal median plane of said body, which elastomer elements each have:
a distal edge at which is arranged an attachment member that engages with a complementary attachment member arranged on a fixed portion of the body,
a proximal edge at which is arranged an attachment member that engages with a complementary attachment member arranged on the rigid wing.
